(19) United States
(12) Patent Application Publication
(10) Pub. No.: US 2023/0081399 A1
(43) Pub. Date: Mar. 16, 2023

(54) SYSTEMS AND METHODS FOR ENRICHMENT OF BREACH DATA FOR SECURITY AWARENESS TRAINING

(71) Applicant: KnowBe4, Inc., Clearwater, FL (US)

(72) Inventor: Colin Murphy, Safety Harbor, FL (US)

(73) Assignee: KnowBe4, Inc., Clearwater, FL (US)

(21) Appl. No.: 17/900,784

(22) Filed: Aug. 31, 2022

Related U.S. Application Data
(60) Provisional application No. 63/244,072, filed on Sep. 14, 2021.

(51) Int. Cl. G06Q 10/06

(52) U.S. Cl. CPC G06Q 10/06395

(57) ABSTRACT

Systems and methods are described for enrichment of breach data for security awareness training. Initially, breached credentials of a user are obtained from breach data of one or more breaches. Analysis of the breached credentials are performed and a level of risk that the breached credentials pose to the organization is determined. Thereafter, a breach score of the user is determined based at least on the level of risk. A remedial action with respect to the user is taken based at least on the breach score.

### RELATED APPLICATIONS

This patent application claims the benefit of and priority to U.S. Provisional Patent Application No. 63/244,072 titled “SYSTEMS AND METHODS FOR ENRICHMENT OF BREACH DATA FOR SECURITY AWARENESS TRAINING,” and filed Sep. 14, 2021, the contents of all of which are hereby incorporated herein by reference in its entirety for all purposes

The present disclosure generally relates to security awareness training. In particular, the present disclosure relates to systems and methods for enrichment of breach data for security awareness training.

### BACKGROUND OF THE DISCLOSURE

Organizations have recognized that cybersecurity incidents are a prominent threat that can cause serious breaches of data including confidential information. These cybersecurity incidents can cost the organizations millions of dollars each year in actual costs and can cause customers to lose trust in the organizations. The number of incidents of cybersecurity attacks and the costs of mitigating the damage is increasing every year. Many organizations invest in cybersecurity tools such as antivirus, anti-ransomware, anti-phishing, and other quarantine platforms. Such cybersecurity tools may detect and intercept known cybersecurity attacks.

A security breach is a cybersecurity incident where information is taken from an organization or an individual by malicious actors without authorization from the organization or individual. The information taken may include sensitive data such as personally identifiable information (PII) and credentials. Malicious actors may launch phishing attacks and attempt to evade organization's security controls and target its employees. In an example, the malicious actors may include sensitive data such as that found in breach data in a phishing message. The inclusion of sensitive data into the phishing message may lend credence to the authenticity of the phishing message. For example, an employee of the organization may recognize his or her credentials in the phishing message and therefore respond to the phishing message. Consequently, the organization may be at a security risk possibly leading to breach of sensitive information of the organization if employees were to act up on phishing messages.

### BRIEF SUMMARY OF THE DISCLOSURE

The present disclosure generally relates to security awareness training. In particular, the present disclosure relates to systems and methods for enrichment of breach data for security awareness training.

Systems and methods are provided for enrichment of breach data for security awareness training. In an example embodiment, a method is described, which includes obtaining breached credentials of a user from breach data of one or more breaches, determining using the breached credentials a credential variation for the user, determining a breach score of the user based at least on the credential variation, and taking a remedial action with respect to the user based at least on the breach score.

In some embodiments, the method further includes analyzing the breached credentials of the user in comparison to organizational credentials of the user to determine the credential variation for the user.

In some embodiments, the method further includes searching the breach data for the breached credentials of the user.

In some embodiments, the method further includes aggregating portions of the breach data with organizational data to provide enhanced data.

In some embodiments, the method further includes analyzing the enhanced data to determine one of reuse, complexity or variation of credentials used by the user.

In some embodiments, the method further includes determining the breach score based at least on a function of reuse, complexity and variation of credentials used by the user.

In some embodiments, the method further includes determining the credential variation based at least on one or more of the following: a number of characters that are different between the breached credentials and the organizational credentials of the user, words within strings of the breached credentials and the organizational credentials of the user that are different but related based on one or more rules, categories or public data.

In some embodiments, the method further includes determining the breach score based at least on one of an amount of information of the user that was included as a part of the one or more breaches or an identification of a website, application or service that the one or more breaches happened within.

In some embodiments, the method further includes communicating a simulated phishing communication to the user, the simulated phishing communication created using one or more of the breach data, organizational data or public data.

In some embodiments, the method further includes taking the remedial action of one of: providing a notification that a breach occurred, prompting the user to change user credentials, or allowing the creation of a simulated phishing communication to the user.

In another example implementation, a system is described which includes one or more servers. The one or more servers are configured to identify breached credentials of a user from breach data of one or more breaches, determine, using the breached credentials, a credential variation for the user, determine a breach score of the user based at least on the credential variation, and take a remedial action with respect to the user based at least on the breach score.

Other aspects and advantages of the disclosure will become apparent from the following detailed description, taken in conjunction with the accompanying drawings, which illustrate by way of example the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising a client device in communication with a server device;

FIG. 1B is a block diagram depicting a cloud computing environment comprising a client device in communication with cloud service providers;

FIG. 1C and FIG. 1D are block diagrams depicting embodiments of computing devices useful in connection with the methods and systems described herein;

FIG. 2 depicts an implementation of some of an architecture of a system for enrichment of breach data for security awareness training, according to some embodiments;

FIG. 3 depicts a flowchart for taking a remedial action with respect to a user based on a breach score, according to some embodiments; and

FIG. 4A and FIG. 4B depict a flowchart for creating a simulated phishing communication for the user, according to some embodiments.

### DETAILED DESCRIPTION

For purposes of reading the description of the various embodiments below, the following descriptions of the sections of the specifications and their respective contents may be helpful:

Section A describes a network environment and computing environment which may be useful for practicing embodiments described herein.

Section B describes embodiments of systems and methods for enrichment of breach data for security awareness training.

### A. Computing and Network Environment

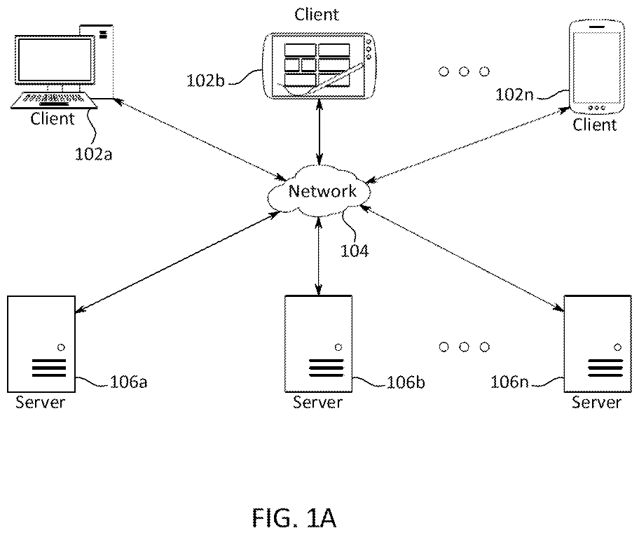

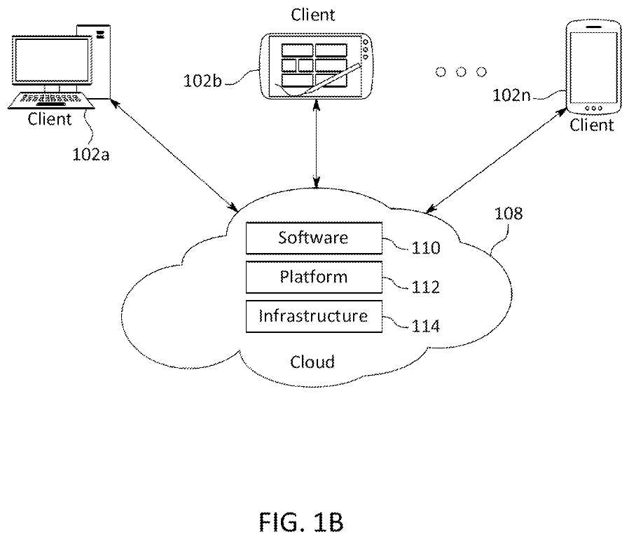

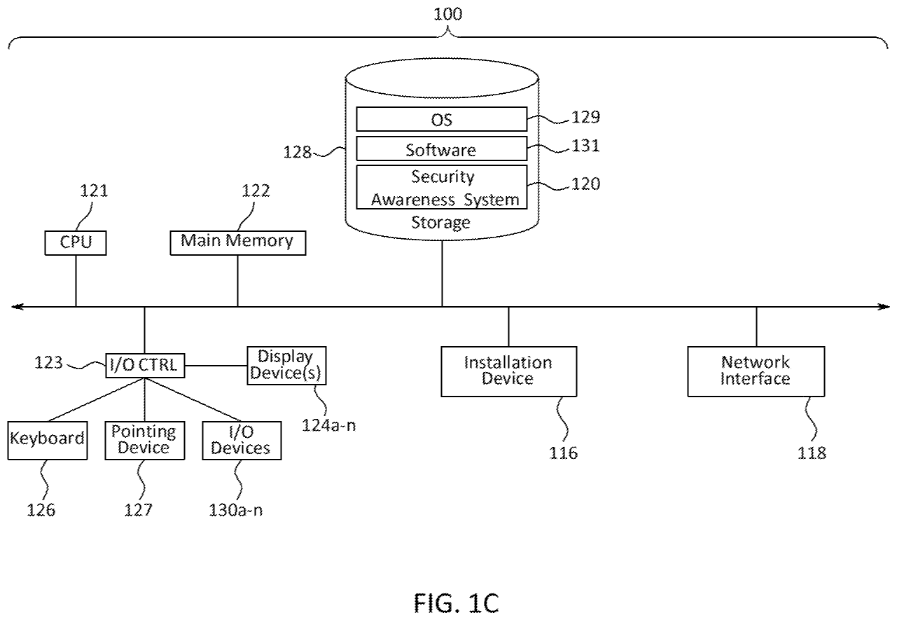

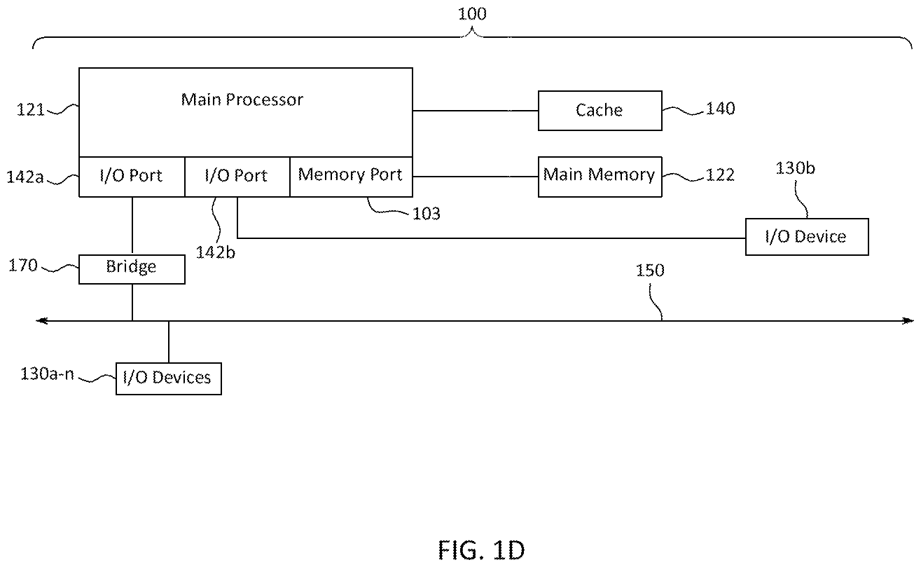

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In a brief overview, the network environment includes one or more clients 102a-102n (also generally referred to as local machines(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node(s) 106, machine(s) 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the client(s) 102 and the server(s) 106, the client(s) 102 and the server(s) 106 may be on the same network 104. In some embodiments, there are multiple networks 104 between the client(s) 102 and the server(s) 106. In one of these embodiments, a network 104′ (not shown) may be a private network and a network 104 may be a public network. In another of these embodiments, a network 104 may be a private network and a network 104′ may be a public network. In still another of these embodiments, networks 104 and 104′ may both be private networks.

The network 104 may be connected via wired or wireless links. Wired links may include Digital Subscriber Line (DSL), coaxial cable lines, or optical fiber lines. Wireless links may include Bluetooth®, Bluetooth Low Energy (BLE), ANT/ANT+, ZigBee, Z-Wave, Thread, Wi-Fi®, Worldwide Interoperability for Microwave Access (WiMAX®), mobile WiMAX®, WiMAX®-Advanced, NFC, SigFox, LoRa, Random Phase Multiple Access (RPMA), Weightless-N/P/W, an infrared channel, or a satellite band. The wireless links may also include any cellular network standards to communicate among mobile devices, including standards that qualify as 1G, 2G, 3G, 4G, LTE or 5G. The network standards may qualify as one or more generations of mobile telecommunication standards by fulfilling a specification or standards such as the specifications maintained by the International Telecommunication Union. The 3G standards, for example, may correspond to the International Mobile Telecommuniations-2000 (IMT-2000) specification, and the 4G standards may correspond to the International Mobile Telecommunication Advanced (IMT-Advanced) specification. Examples of cellular network standards include AMPS, GSM, GPRS, UMTS, CDMA2000, CDMA-1xRTT, CDMA-EVDO, LTE, LTE-Advanced, LTE-M1, and Narrowband IoT (NB-IoT). Wireless standards may use various channel access methods, e.g., FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network may vary widely and the network 104 can be a body area network (BAN), a personal area network (PAN), a local-area network (LAN), e.g., Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include the application layer, transport layer, internet layer (including, e.g., IPv4 and IPv6), or the link layer. The network 104 may be a type of broadcast network, a telecommunications network, a data communication network, or a computer network.

In some embodiments, the system may include multiple logically-grouped servers 106. In one of these embodiments, the logical group of servers may be referred to as a server farm or a machine farm. In another of these embodiments, the servers 106 may be geographically dispersed. In other embodiments, a machine farm may be administered as a single entity. In still other embodiments, the machine farm includes a plurality of machine farms. The servers 106 within each machine farm can be heterogeneous-one or more of the servers 106 or machine(s) 106 can operate according to one type of operating system platform (e.g., Windows, manufactured by Microsoft Corp. of Redmond, Washington), while one or more of the other servers 106 can operate according to another type of operating system platform (e.g., Unix, Linux, or Mac OSX).

In one embodiment, servers 106 in the machine farm may be stored in high-density rack systems, along with associated storage systems, and located in an enterprise data center. In this embodiment, consolidating the servers 106 in this way may improve system manageability, data security, the physical security of the system, and system performance by locating servers 106 and high-performance storage systems on localized high-performance networks. Centralizing the servers 106 and storage systems and coupling them with advanced system management tools allows more efficient use of server resources.

The servers 106 of each machine farm do not need to be physically proximate to another server 106 in the same machine farm. Thus, the group of servers 106 logically grouped as a machine farm may be interconnected using a wide-area network (WAN) connection or a metropolitan-area network (MAN) connection. For example, a machine farm may include servers 106 physically located in different continents or different regions of a continent, country, state, city, campus, or room. Data transmission speeds between servers 106 in the machine farm can be increased if the servers 106 are connected using a local-area network (LAN) connection or some form of direct connection. Additionally, a heterogeneous machine farm may include one or more server(s) 106 operating according to a type of operating system, while one or more other servers execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMWare ESX/ESXI, manufactured by VMWare, Inc., of Palo Alta, Calif.; the Xen hypervisor, an open source product whose development is overseen by Citrix Systems, Inc. of Fort Lauderdale, Fla; the HYPER-V hypervisors provided by Microsoft, or others. Hosted hypervisors may run within an operating system on a second software level. Examples of hosted hypervisors may include VMWare, Workstation and VirtualBox, manufactured by Oracle Corporation of Redwood City, Calif.

Management of the machine farm may be de-centralized. For example, one or more server(s) 106 may comprise components, subsystems, and modules to support one or more management services for the machine farm. In one of these embodiments, one or more server(s) 106 provide functionality for management of dynamic data, including techniques for handling failover, data replication, and for increasing the robustness of the machine farm. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, a plurality of servers 106 may be in the path between any two communicating servers 106.

Referring to FIG. 1B, a cloud computing environment is depicted. A cloud computing environment may provide client 102(s) with one or more resources provided by a network environment. The cloud computing environment may include one or more client(s) 102a-102n, in communication with the cloud 108 over one or more network(s) 104. Client(s) 102 may include, e.g., thick clients, thin clients, and zero clients. A thick client may provide at least some functionality even when disconnected from the cloud 108 or server(s) 106. A thin client or zero client may depend on the connection to the cloud 108 or server(s) 106 to provide functionality. A zero client may depend on the cloud 108 or other network(s) 104 or server(s) 106 to retrieve operating system data for the client device 102. The cloud 108 may include back end platforms, e.g., server(s) 106, storage, server farms or data centers.

The cloud 108 may be public, private, or hybrid. Public clouds may include public server(s) 106 that are maintained by third parties to the client(s) 102 or the owners of the client(s). The server(s) 106 may be located off-site in remote geographical locations as disclosed above or otherwise. Public clouds may be connected to the server(s) 106 over a public network. Private clouds may include private server(s) 106 that are physically maintained by client(s) 102 or owners of clients. Private clouds may be connected to the server(s) 106 over a private network 104. Hybrid clouds 109 may include both the private and public network(s) 104 and server(s) 106.

The cloud 108 may also include a cloud-based delivery, e.g., software as a Service (SaaS) 110, Platform as a Service (PaaS) 112, and Infrastructure as a Service (IaaS) 114. IaaS may refer to a user renting the user of infrastructure resources that are needed during a specified time period. IaaS provides may offer storage, networking, servers, or virtualization resources from large pools, allowing the users to quickly scale up by accessing more resources as needed. Examples of IaaS include Amazon Web Services (AWS) provided by Amazon, Inc. of Seattle, Wash., Rackspace Cloud provided by Rackspace Inc. of San Antonio, Tex., Google Compute Engine provided by Google Inc. of Mountain View, Calif., or RightScale provided by RightScale, Inc. of Santa Barbara, Calif. PaaS providers may offer functionality provided by IaaS, including, e.g., storage, networking, servers, or virtualization, as well as additional resources, e.g., operating system, middleware, or runtime resources. Examples of PaaS include Windows Azure provided by Microsoft Corporation of Redmond, Wash., Google App Engine provided by Google Inc., and Heroku provided by Heroku, Inc. of San Francisco Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include Google Apps provided by Google Inc., Salesforce provided by Salesforce.com Inc. of San Francisco, Calif., or Office365 provided by Microsoft Corporation. Examples of SaaS may also include storage providers, e.g., Dropbox provided by Dropbox Inc. of San Francisco, Calif., Microsoft OneDrive provided by Microsoft Corporation, Google Drive provided by Google Inc., or Apple iCloud provided by Apple Inc. of Cupertino, Calif.

Client(s) 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP and may use Representational State Transfer (REST) protocol or Simple Object Access Protocol (SOAP). Client(s) 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Client(s) 102 may access SaaS resources through the use of web-based user interfaces, provided by a web browser (e.g., Google Chrome, Microsoft Internet Explorer, or Mozilla Firefox provided by Mozilla Foundation of Mountain View, Calif). Client(s) 102 may also access SaaS resources through smartphone or tablet applications, including e.g., Salesforce Sales Cloud, or Google Drive App. Client(s) 102 may also access SaaS resources through the client operating system, including e.g., Windows file system for Dropbox.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client(s) 102 and server(s) 106 may be deployed as and/or executed on any type and form of computing device, e.g., a computer, network device or appliance capable of communicating on any type and form of network and performing the operations described herein.

FIG. 1C and FIG. 1D depict block diagrams of a computing device 100 useful for practicing an embodiment of the client(s) 102 or server(s) 106. As shown in FIG. 1C and FIG. 1D, each computing device 100 includes a central processing unit 121, and a main memory unit 122. As shown in FIG. 1C, a computing device 100 may include a storage device 128, an installation device 116, a network interface 118, and I/O controller 123, display devices 124a-124n, a keyboard 126, and a pointing device 127, e.g., a mouse. The storage device 128 may include, without limitation, an operating system 129, software 131, and a software of a security awareness system 120. As shown in FIG. 1D, each computing device 100 may also include additional optional elements, e.g., a memory port 103, a bridge 170, one or more input/output devices 130a-130n (generally referred to using reference numeral 130), and a cache memory 140 in communication with the central processing unit 121.

The central processing unit 121 is any logic circuity that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, New York; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE 15 and INTEL CORE 17.

Main memory unit 122 may include on or more memory chips capable of storing data and allowing any storage location to be directly accessed by the microprocessor 121. Main memory unit 122 may be volatile and faster than storage 128 memory. Main memory units 122 may be Dynamic Random-Access Memory (DRAM) or any variants, including static Random-Access Memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change RAM (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts and embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, a PCI-Express bus, or a NuBus. For embodiments in which the I/O device is a video display 124, the processor 121 may use an Advanced Graphic Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex cameras (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple iPhone. Some devices 130a-130n allow gesture recognition inputs through combining some of the inputs and outputs. Some devices 130a-130n provide for facial recognition which may be utilized as an input for different purposes including authentication and other commands. Some devices 130a-130n provide for voice recognition and inputs, including, e.g., Microsoft KINECT, SIRI for iPhone by Apple, Google Now or Google Voice Search, and Alexa by Amazon.

Additional devices 130a-130n have both input and output capabilities, including, e.g., haptic feedback devices, touchscreen displays, or multi-touch displays. Touchscreen displays, multi-touch displays, touchpads, touch mice, or other touch sensing devices may use different technologies to sense touch, including, e.g., capacitive, surface capacitive, projected capacitive touch (PCT), in cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augmented reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections to receive handheld USB storage devices. In further embodiments, a I/O device 130 may be a bridge between the system bus 150 and an external communication bus, e.g., a USB bus, a SCSI bus, a FireWire bus, an Ethernet bus, a Gigabit Ethernet bus, a Fiber Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode (LED) displays, digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g., stereoscopy, polarization filters, active shutters, or auto stereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect, or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network(s) 104. In some embodiments, software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g., one or more hard disk drives or redundant arrays of independent disks) for storing an operating system or other related software, and for storing application software programs such as any program related to security awareness system 120. Examples of storage device(s) 128 include, e.g., hard disk drive (HDD); optical drive including CD drive, DVD drive, or BLU-RAY drive; solid-state drive (SSD); USB flash drive; or any other device suitable for storing data. Some storage device(s) may include multiple volatile and non-volatile memories, including, e.g., solid state hybrid drives that combine hard disks with solid state cache. Some storage device(s) 128 may be non-volatile, mutable, or read-only. Some storage device(s) 128 may be internal and connect to the computing device 100 via a bus 150. Some storage device(s) 128 may be external and connect to the computing device 100 via a I/O device 130 that provides an external bus. Some storage device(s) 128 may connect to the computing device 100 via the network interface 118 over a network(s) 104, including, e.g., the Remote Disk for MACBOOK AIR by Apple. Some client devices 100 may not require a non-volatile storage device 128 and may be thin clients or zero client(s) 102. Some storage device(s) 128 may also be used as an installation device 116 and may be suitable for installing software and programs. Additionally, the operating system and the software can be run from a bootable medium, for example, a bootable CD, e.g., KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device(s) 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, InfiniBand), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.1 1a/b/g/n/ac CDMA, GSM, WiMAX, and direct asynchronous connections). In one embodiment, the computing device 100 communicates with other computing devices 100′ via any type and/or form of gateway or tunneling protocol e.g., Secure Socket Layer (SSL) or Transport Layer Security (TLS), or the Citrix Gateway Protocol manufactured by Citrix Systems, Inc. The network interface 118 may comprise a built-in network adapter, network interface card, PCMCIA network card, EXPRESSCARD network card, card bus network adapter, wireless network adapter, USB network adapter, modem, or any other device suitable for interfacing the computing device 100 to any type of network capable of communication and performing the operations described herein.

A computing device 100 of the sort depicted in FIG. 1B and FIG. 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, WINDOWS 8 and WINDOW 10, all of which are manufactured by Microsoft Corporation of Redmond, Washington; MAC OS and IOS, manufactured by Apple, Inc.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google Inc., among others. Some operating systems, including, e.g., the CHROME OS by Google Inc., may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, or a NINTENDO DS, NINTENDO 3DS, NINTENDO WII, or a NINTENDO WII U device manufactured by Nintendo Co., Ltd., of Kyoto, Japan, or an XBOX 360 device manufactured by Microsoft Corporation.

In some embodiments, the computing device 100 is a digital audio player such as the Apple iPOD, iPOD Touch, and iPOD NANO lines of devices, manufactured by Apple Computer of Cupertino, California. Some digital audio players may have other functionality, including, e.g., a gaming system or any functionality made available by an application from a digital application distribution platform. For example, the iPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g., the iPAD line of devices by Apple; GALAXY TAB family of devices by Samsung; or KINDLE FIRE, by Amazon.com, Inc. of Seattle, Washington. In other embodiments, the computing device 100 is an eBook reader, e.g., the KINDLE family of devices by Amazon.com, or NOOK family of devices by Barnes & Noble, Inc. of New York City, N.Y.

In some embodiments, the communications device 102 includes a combination of devices, e.g., a smartphone combined with a digital audio player or portable media player. For example, one of these embodiments is a smartphone, e.g., the iPhone family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g., a telephony headset. In these embodiments, the communications device(s) 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network(s) 104 is monitored, generally as part of network management. In one of these embodiments, the status of a machine may include an identification of load information (e.g., the number of processes on the machine, CPU, and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Systems and Methods for Enrichment of Breach Data for Security Awareness Training

The present disclosure generally relates to security awareness training. In particular, the present disclosure relates to systems and methods for enrichment of breach data for security awareness training.

The present disclosure provides an efficient way of identifying and minimizing the attack surfaces of users of an organization that have their data leaked as a part of a breach. In an example, the users may be employees of the organization. Further, in an example, an attack surface of a user may be a set of points in an environment where a malicious actor can try to enter, cause an effect on, or extract data from the environment. A user with a larger attack surface is more exposed to and susceptible to an attack from a malicious actor. According to an implementation, data of the users that is leaked as a part of the breach may pose a risk to both the users and the organization. In an implementation, the present disclosure provides solutions for identifying such risk and training to users to minimize the risk.

The present disclosure leverages a security awareness system for identifying and minimizing the attack surface of users. In an implementation, the security awareness system may obtain breach data and enhance the breach data with organizational data and public data. In an example, the breach data may refer to data from one or more breaches where malicious actors gain unauthorized access to the data of the user from one or more other organizations. For example, the breach data may include names of the user, email addresses of the user, the password of the user in clear text or encrypted or any other data associated with the user. The organizational data may include private data from the organization that is associated with the user. The private data may include user data, organizational credentials, or any other data that the organization may have regarding the user. In an example, the public data may include data from one or more public data sources that is associated with the user. The public data may include public records such as licensing records and social media data. According to an implementation, the security awareness system may analyze the enhanced breach data for reuse, variation, and complexity. A breach score of each of the users may be created and used to determine a remedial action with respect to each of the users. In an example, the breach score may be a metric made up of one or more components that measures a level of risk that breach data pose to the organization. According to some implementations, the security awareness system may communicate one or more simulated phishing communications to the users as a part of the remedial action to provide security awareness training to the users. The security awareness training may refer to a training that is used to educate the users in the organization about security threats around computer systems and/or the Internet. In an example, the security awareness training may educate the users about what constitutes security threats, how to identify security threats, how to report security threats, and how to prevent or to reduce the success rate of security threats on the users.

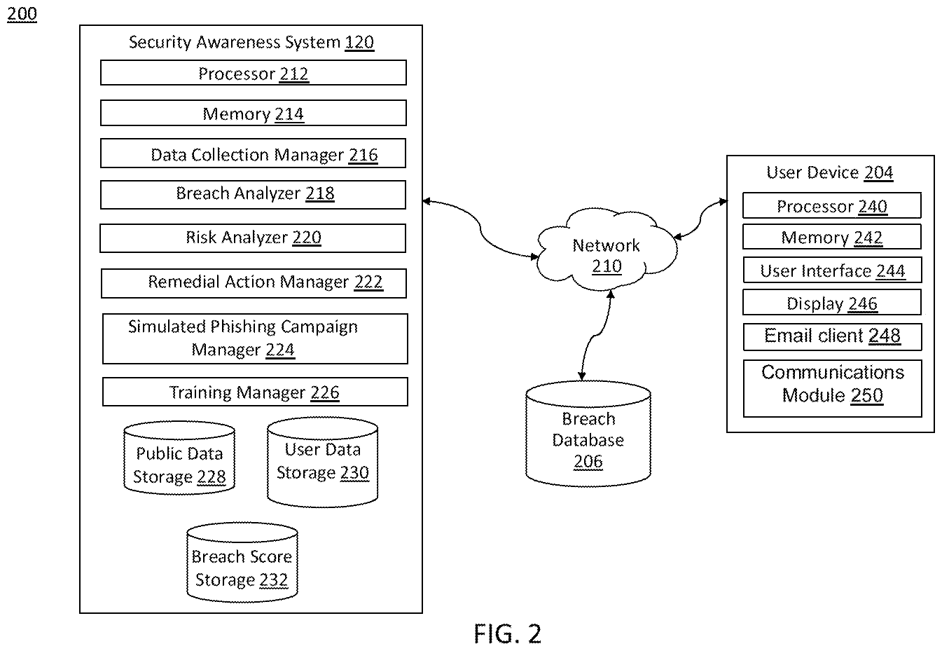

FIG. 2 depicts some of the server architecture of an implementation of system 200 for enrichment of breach data for security awareness training of users of an organization, according to some embodiments. System 200 may include security awareness system 120, user device 204, breach database 206, and network 210 enabling communication between the system components for information exchange. Network 210 may be an example or instance of network 104, details of which are provided with reference to FIG. 1A and its accompanying description.

According to one or more embodiments, security awareness system 120 may be implemented in a variety of computing systems, such as a mainframe computer, a server, a network server, a laptop computer, a desktop computer, a notebook, a workstation, and any other computing system. In an implementation, security awareness system 120 may be implemented in a server, such as server 106 shown in FIG. 1A. In some implementations, security awareness system 120 may be implemented by a device, such as computing device 100 shown in FIG. 1C and FIG. 1D. In some embodiments, security awareness system 120 may be implemented as a part of a cluster of servers. In some embodiments, security awareness system 120 may be implemented across a plurality of servers, thereby, tasks performed by security awareness system 120 may be performed by the plurality of servers. These tasks may be allocated among the cluster of servers by an application, a service, a daemon, a routine, or other executable logic for task allocation. The term “application” as used herein may refer to one or more applications, services, routines, or other executable logic or instructions. Security awareness system 120 may comprise a program, service, task, script, library, application or any type and form of executable instructions or code executable on one or more processors. Security awareness system 120 may be implemented by one or more modules, applications, programs, services, tasks, scripts, libraries, applications, or executable code.

In some embodiments, security awareness system 120 may be owned, managed or otherwise associated with an organization or any entity authorized thereof. In an implementation, security awareness system 120 may manage cybersecurity awareness for the organization. In an example, the organization may be an entity that is subscribed to or makes use of services provided by security awareness system 120. The organization may encompass all users within the organization, vendors to the organization, and/or partners of the organization. In an implementation, security awareness system 120 may be a platform that monitors, identifies, and manages cybersecurity attacks including phishing attacks faced by the organization or by the users of the organization. In an example, a user of the organization may include an individual that can or does receive an electronic message. For example, the user may be an employee of the organization, a member of a group, an individual who acts in any capacity of security awareness system 120, such as a security authority, or anyone associated with the organization. The security authority may be a professional (or a team of professionals) managing organizational cybersecurity aspects. The security authority may oversee and manage security awareness system 120 to ensure cybersecurity goals of the organization are met. For example, the security authority may oversee Information Technology (IT) systems of the organization for managing simulated phishing campaigns, identification and classification of threats within reported emails, selection of simulated phishing communications (or simulated phishing messages), and any other element within security awareness system 120. Examples of the security authority include an IT department, a security team, a manager, or an Incident Response (IR) team. A simulated phishing campaign is a technique of testing a user to determine whether the user is likely to recognize a true malicious phishing attack and act appropriately upon receiving the malicious phishing attack. A simulated phishing communication may mimic a real phishing message and appear genuine to entice a user to respond/interact with the simulated phishing communication. The simulated phishing communication may include links, attachments, macros, or any other simulated phishing threat that resembles a real phishing threat.

According to some embodiments, security awareness system 120 may include processor 212 and memory 214. For example, processor 212 and memory 214 of security awareness system 120 may be CPU 121 and main memory 122, respectively, as shown in FIG. 1C and FIG. 1D. According to an embodiment, security awareness system 120 may include data collection manager 216, breach analyzer 218, risk analyzer 220, remedial action manager 222, simulated phishing campaign manager 224, and training manager 226. In an implementation, data collection manager 216, breach analyzer 218, risk analyzer 220, remedial action manager 222, simulated phishing campaign manager 224, and training manager 226 may be applications or programs communicatively coupled to processor 212 and memory 214. In some embodiments, data collection manager 216, breach analyzer 218, risk analyzer 220, remedial action manager 222, simulated phishing campaign manager 224, and training manager 226, amongst other units, may include routines, programs, objects, components, data structures, etc., which may perform particular tasks or implement particular abstract data types. Data collection manager 216, breach analyzer 218, risk analyzer 220, remedial action manager 222, simulated phishing campaign manager 224, and training manager 226 may also be implemented as signal processor(s), state machine(s), logic circuitries, and/or any other device or component that manipulate signals based on operational instructions.

In some embodiments, data collection manager 216, breach analyzer 218, risk analyzer 220, remedial action manager 222, simulated phishing campaign manager 224, and training manager 226 may be implemented in hardware, instructions executed by a processing module, or by a combination thereof. In examples, the processing module may be main processor 121 as shown in FIG. 1D. The processing module may comprise a computer, a processor, a state machine, a logic array, or any other suitable devices capable of processing instructions. The processing module may be a general-purpose processor which executes instructions to cause the general-purpose processor to perform the required tasks or, the processing module may be dedicated to perform the required functions. In some embodiments, data collection manager 216, breach analyzer 218, risk analyzer 220, remedial action manager 222, simulated phishing campaign manager 224, and training manager 226 may be machine-readable instructions which, when executed by a processor/processing module, perform intended functionalities of data collection manager 216, breach analyzer 218, risk analyzer 220, remedial action manager 222, simulated phishing campaign manager 224, and training manager 226. The machine-readable instructions may be stored on an electronic memory device, hard disk, optical disk, or other machine-readable storage medium or non-transitory medium. In an implementation, the machine-readable instructions may also be downloaded to the storage medium via a network connection. In an example, machine-readable instructions may be stored in memory 214.

Referring again to FIG. 2, in some embodiments, security awareness system 120 may include public data storage 228, user data storage 230, and breach score storage 232. Public data storage 228 may include data associated with the users of the organization that is obtained from one or more public data sources. The data obtained from the public data sources may interchangeably be referred to as public data. In an example, the public data may include any information that is publicly available on the internet related to the users. For example, the public data may include social media data, public records such as licensing records and birth records, and open-source intelligence (OSINT) data. In some examples, user data storage 230 may include data associated with the users collected by data collection manager 216. User data storage 230 may include data associated with the users of the organization that is obtained from the organization. The data obtained from the organization may interchangeably be referred to as organizational data. In an example, the organizational data may refer to private data obtained from the organization that is associated with the users. The organizational data may include personally identifiable information (PII), user data, organizational credentials, or any other data that the organization may have regarding its users. In some examples, user data storage 230 may include data associated with the users collected by data collection manager 216. Breach score storage 232 may include breach scores of the users. A breach score may be a metric made up of one or more components that measures the level of risk that credentials that are breached pose to the organization and used to determine appropriate remedial actions and training. Information related to public data stored in public data storage 228, information related to the organizational data stored in user data storage 230, and information related to the breach scores of the users stored in breach score storage 232 may be periodically or dynamically updated as required. In an implementation, public data storage 228, user data storage 230, and breach score storage 232 may include any type or form of storage, such as a database or a file system coupled to memory 214.

Referring again to FIG. 2, in some embodiments, user device 204 may be any device used by a user. The user may be an employee of an organization, a client, a vendor, a customer, a contractor, or any person associated with the organization. User device 204 may be any computing device, such as a desktop computer, a laptop, a tablet computer, a mobile device, a Personal Digital Assistant (PDA), or any other computing device. In an implementation, user device 204 may be a device, such as client device 102 shown in FIG. 1A and FIG. 1B. User device 204 may be implemented by a device, such as computing device 100 shown in FIG. 1C and FIG. 1D. According to some embodiments, user device 204 may include processor 240 and memory 242. In an example, processor 240 and memory 242 of user device 204 may be CPU 121 and main memory 122, respectively, as shown in FIG. 1C and FIG. 1D. User device 204 may also include user interface 244, such as a keyboard, a mouse, a touch screen, a haptic sensor, a voice-based input unit, or any other appropriate user interface. It shall be appreciated that such components of user device 204 may correspond to similar components of computing device 100 in FIG. 1C and FIG. 1D, such as keyboard 126, pointing device 127, I/O devices 130a-n and display devices 124a-n. User device 204 may also include display 246, such as a screen, a monitor connected to the device in any manner, or any other appropriate display. In an implementation, user device 204 may display received content (for example, messages) for the user using display 246 and is able to accept user interaction via user interface 244 responsive to the displayed content.

In some implementations, user device 204 may include a communications module 250. This may be a library, Application Programming Interface (API), a set of scripts, or any other code that may facilitate communications between user device 204 and security awareness system 120, a third-party server, or any other server. In some embodiments, the communications module determines when to transmit information from user device 204 to external servers via network 210. In some embodiments, the communications module receives information from security awareness system 120, via network 210. In some embodiments, the information transmitted or received by the communications module may correspond to a message, such as an email generated, or received by a messaging application.

Referring again to FIG. 2, in some embodiments, user device 204 may include email client 248. In one example implementation, email client 248 may be a messaging application installed on user device 204. In another example implementation, email client 248 may be an application that can be accessed over network 210 without being installed on user device 204. In an implementation, email client 248 may be any application capable of composing, sending, receiving, and reading email messages. In an example, email client 248 may facilitate a user to create, receive, organize, and otherwise manage email messages. In an implementation, email client 248 may be an application that runs on user device 204. In some implementations, email client 248 may be an application that runs on a remote server or on a cloud implementation and is accessed by a web browser. For example, email client 248 may be an instance of an application that allows viewing of a desired message type, such as any web browser, Microsoft Outlook™ application (Microsoft, Mountain View, Calif.), IBM® Lotus Notes® application, Apple® Mail application, Gmail® application (Google, Mountain View, Calif.), WhatsApp™ (Facebook, Menlo Park, Calif.), a text messaging application, or any other known or custom email application. In some embodiments, email client 248 can be configured to display spoofed domain electronic training. In an example, a user of user device 204 may be mandated to download and install email client 248 by the organization. In another example, email client 248 may be provided by the organization as default. In some examples, a user of user device 204 may select, purchase and/or download email client 248 through an application distribution platform. In some examples, user device 204 may receive simulated phishing communications via email client 248.

Referring back to FIG. 2, according to some embodiments, breach database 206 may be a dynamic database that includes a public database and/or a private database. In an implementation, breach database 206 may be a third-party database. In a non-limiting example, breach database 206 may include information related to user login credentials of the users of the organization which have been breached. Examples of user login credentials may include a username, an email address, and/or a password. A username is a unique combination of characters, such as letters of the alphabet and/or numbers, that identifies a specific user. The user may gain access to a website using the user login credentials. In an example implementation, security awareness system 120 may determine whether user login credentials including a username and/or an email address is associated with a data breach if the username and/or the email address is found in breach database 206. In an example, security awareness system 120 may verify if the email address associated with the user is involved in a security breach using websites such as “https://haveibeenpwned.com/” and “https://spycloud.com/”.

According to an implementation, data collection manager 216 may be configured to retrieve or obtain breach data from breach database 206. In an example, the breach data may refer to data from one or more breaches where malicious actors gain unauthorized access to data from one or more other organizations. A breach may refer to a cybersecurity incident where information is taken from an organization by malicious actors without knowledge or authorization from the organization. The information taken may include sensitive data such as personally identifiable information (PII) and credentials of users of the organization. Credentials may refer to information that enables users to login and verify their identities to their online accounts. Credentials may includer user login credentials. Examples of credentials include, but are not limited to, usernames, passwords, email addresses, postal index number (PIN) codes, security questions and answers, and biometric data. In an example, the breach data may include credentials of the users of one nor more organizations. For example, the breach data may include names of the users, email addresses of the users, and other PII related to the users. In some examples, the breach data may include information about the breached organization itself, such as research and development data, client information, and financial information. According to an implementation, data collection manager 216 may retrieve the breach data in a hashed, encrypted, or plaintext format.

In an implementation, data collection manager 216 may search the breach data to determine if a user of the organization has been compromised in a breach. In an example, the user may be a user of user device 204. For ease of explanation and understanding, the description provided in the present disclosure is with reference to a single user, however, the description is equally applicable to more than one user.

According to an implementation, data collection manager 216 may obtain breached credentials of the user from the breach data of the one or more breaches. The breached credentials may refer to credentials that are found in the breach data and have been subject to a breach from one or more other organizations. The one or more other organizations may be organizations where the user may have an account that are separate from the organization where the user may be employed. In an example, a risk is introduced to the organization where the user is employed when one or more other organizations are breached where the user credentials are the same or similar to the user's organizational credentials.

According to an implementation, data collection manager 216 may search the breach data for the breached credentials of the user. In an example, data collection manager 216 may search for a username of the user in the breach data. In some examples, data collection manager 216 may search for an email address associated with the user within the organization in the breach data. For example, if the email address of the user is “user08@examplecompany.com”, data collection manager 216 may search for the email address “user08@examplecompany.com” in the breach data. If the email address is found within the breach data, data collection manager 216 may determine that the user has been a part of the breach. In an implementation, data collection manager 216 may organize the breached credentials into types of data, such as first name, last name, username, and email address associated with the user. The breached credentials that are organized into the types of data may be used for the creation of simulated phishing communications. The manner in which the breached credentials are used for the creation of simulated phishing communications is described later in the description.

According to an implementation, if the user that is a part of the organization has his or her information found within the breach data, data collection manager 216 may store the data associated with the user of the organization in user data storage 230. In some implementations, data collection manager 216 may retrieve public data associated with the user from the one or more public data sources and store the public data in public data storage 228. In an example implementation, data collection manager 216 may retrieve the public data from the one or more public data sources using open-source intelligence. According to an implementation, data collection manager 216 may hash the organizational data and the public data before storing in user data storage 230 and public data storage 228, respectively. The organizational data and the public data may be used for enhancing or enriching the breach data.

In some implementations, data collection manager 216 may filter or query the breach data for an email domain of the organization to determine all users of the organization that were a part of a breach. In an example, the email domain of the organization may be “@examplecompany.com”. Accordingly, data collection manager 216 may query the breach data for the email domain of the organization. In an implementation, data collection manager 216 may add the users that are determined to be a part of the breach to one or more smart groups. In an example, a smart group may be a query based group that accurately and automatically builds a list of users that meet specified criteria at the moment that the group is created, requested, or used. According to an example, the users determined to be the part of the breach may be added to a “Breached Users” smart group.

According to some implementations, data collection manager 216 may refrain from retrieving or obtaining breach data from breach database 206 that is deemed to be sensitive or may obscure such data. According to an implementation, data collection manager 216 may partially obscure the sensitive data. In an example, data collection manager 216 may refrain from retrieving any data that includes sensitive information such as an address, a phone number, a credit card number, a social security number, or any other information that is deemed sensitive.

According to an example, the breached credentials obtained from the breach data may be highly sensitive and used for abuse by a malicious actor. The malicious actor may be able to deduce user credentials at the organization using the breached credentials from one or more other organizations. For example, the malicious actor may test similar or related passwords, use the breach data to gain unauthorized access to other accounts of the user and gain further information useful to gaining access to the organization's systems, combine breach data with other data sources, such as social media, to further increase their knowledge of the user and more accurately deduce other likely credentials. In an example, a malicious actor may be able to establish a pattern or other common traits in the user's password leading to an increased ability to deduce, or otherwise arrive at the user's credentials at the organization. Owing to the risk associated with the breach data, the organization may want to determine how much risk the breached credentials may pose. The level of risk may be influenced by or determined by how much the breached credentials resemble organizational credentials of the user or whether the organizational credentials can be easily predicted based on the breached credentials.

In an implementation, breach analyzer 218 may aggregate at least portions of the breach data with the organizational data and/or the public data to provide enhanced data. According to an implementation, breach analyzer 218 may analyze the enhanced data to determine one of reuse, complexity, or variation of credentials used by the user. Although it has been described that breach analyzer 218 aggregates at least portions of the breach data with the organizational data and/or the public data to provide the enhanced data and breach analyzer 218 analyzes the enhanced data, in some implementations, data collection manager 216 may aggregate at least portions of the breach data with the organizational data and/or the public data to provide the enhanced data, and breach analyzer 218 may analyze the enhanced data.

According to an implementation, breach analyzer 218 may be configured to analyze the breached credentials of the user for reuse, complexity, and variation in relation to organizational credentials of the user stored in user data storage 230. In an example implementation, breach analyzer 218 may analyze the breached credentials using artificial intelligence (AI) or machine learning (ML) techniques. In an implementation, breach analyzer 218 may analyze the breached credentials for reuse by determining whether the breached credentials have been replicated exactly by the user. In an example implementation, breach analyzer 218 may analyze the breached credentials of the user in comparison to the organizational credentials of the user. In an example, breach analyzer 218 may compare a hash of the breached credentials to a hash of the organizational credentials. For example, breach analyzer 218 may compare an email address (or a hash of an email address) from the breached credentials to an email address (or a hash of an email address) from the organizational credentials. If the two email addresses are exactly the same, then breach analyzer 218 may determine that the email address that was leaked in the breach is exactly the same email address that the user currently uses in the organization. According to an implementation, breach analyzer 218 may determine reuse of credentials between users of the organization. In an example, when a password as a part of the breached credentials in the breach data is associated with one user, breach analyzer 218 may determine if another user within the organization has the same password. If the password of another user is same, then breach analyzer 218 may determine that there is credential reuse.

According to an implementation, breach analyzer 218 may analyze the breached credentials for complexity by determining whether the breached credentials have varied use of uppercase characters, lowercase characters, symbols, and numbers. In an example, a credential complexity may determine how easily a password could be cracked in a brute force attack. In an example, breach analyzer 218 may use a set of rules for analyzing the breached credentials for complexity. In an example implementation, the set of rules may be pre-configured by the security authority. In some examples, breach analyzer 218 may use the set of rules to analyze the breached credentials for compliance with organizational policy or standards such as National Institute of Standards and Technology (NIST) standards. For example, the set of rules may be configured to determine that a password that does not include numbers or symbols has low complexity and a password that includes more than ten characters has high complexity. In an example, breach analyzer 218 may perform an analysis on clear text breached credentials.

According to an implementation, breach analyzer 218 may analyze the breached credentials to determine a credential variation for the user. In an example, credential variation may refer to an amount of difference between credentials. In an example, if two passwords are identical, then the two passwords may not have any variation. In some examples, if the two passwords are same except for one character, then variation between the two passwords may be low. In an implementation, breach analyzer 218 may determine the credential variation based at least on one or more of a number of characters that are different between the breached credentials and the organizational credentials of the user, words within strings of the breached credentials, and the organizational credentials of the user that are different but related based on one or more rules, categories, or the public data.

In an implementation, breach analyzer 218 may analyze the breached credentials of the user in comparison to the organizational credentials of the user to determine the credential variation for the user. In an example, if a user has his or her first child's name and birth date as a breached password and second child's name and birth date as an organizational password, then breach analyzer 218 may detect that the breached password has a low variation (since the breached password is similar to the organizational password).

According to an implementation, breach analyzer 218 may apply one or more variation rules to the breached credentials to create the credential variation. In an example, a variation rule may allow for replacement of number “0” with letter “O” and vice versa to create a variation on a breached password. In some examples, a variation rule may allow for addition of number “1” at an end of a password to create a variation on the breached password. This may lead to a credential that is the string “password” having variations “password1”, “passw0rd”, and “passw0rd1”. In an implementation, breach analyzer 218 may use the public data stored in public data storage 228 to create variations on the credentials. In an example, the stored public data may indicate that a user has an anniversary in year 1952 (for example, based on a social media activity of the user). Breach analyzer 218 may create variations with the string “1952” in the passwords. According to an implementation, breach analyzer 218 may use natural language processing (NLP) tools such as semantic analysis and semantic matching techniques to separate components of the credentials and create credential variations. For example, the credential “Paris1999” may be analyzed by breach analyzer 218 using NLP tools to recognize two components—“Paris” (a noun referring to a city in France) and “1999” (referring to a year). In an example, the semantic matching technique may be used for creation of variations that are more or less similar to the credential, such as “Tokyo2020”.

In an implementation, breach analyzer 218 may also create variations on the breached credentials based on deductions made using AI or ML techniques. In an example, a determination that the user's password includes names of his or her two pets may prompt breach analyzer 218 to create variations of the password with other possible pet names from the public data or from other common pet names. In some implementations, breach analyzer 218 may use stored public data and organizational data to deduce variations of the credentials. Breach analyzer 218 may create variations on the breach credentials at different levels for comparison. For example, if a user's credential that is breached is “orange2345”, then breach analyzer 218 may create a variation of the user's credential as “orange6789” at a variation of 60 percent that matches the organizational credentials. Breach analyzer 218 may then determine the variation of the breached credentials or the organizational credentials to be 60 percent.

In some implementations, breach analyzer 218 may compare variations on the breached credentials to the organizational credentials to determine if there is a match. In case there is a match, it may further determine if the organizational credentials can be deduced from the breached credentials. In an example, breach analyzer 218 may compare the breached credentials and the variations of the breached credentials to the organizational credentials. In some examples, breach analyzer 218 may compare hashes of the breached credentials and hashes of the variations of the breached credentials to hashes of the organizational credentials. In an example implementation, when variations of different levels are compared to the organizational credentials, and there is a match, the organizational credentials can be determined to be at the corresponding level of variation. In an example, if a breached credential is a username “carrot”, and a variation of the breached credential is “carrot1” and is categorized as a low variation credential, and further if an organizational credential is found to be “carrot1”, then the credential that is breached may be categorized as a low variation credential.

According to an implementation, risk analyzer 220 may be configured to determine a level of risk that the breached credentials pose to the organization. In an example, the level of risk may be determined by the amount of information that was included as a part of the breach, for example, whether only a username was included in the breach or a username and a password both were included in a breach. In an implementation, risk analyzer 220 may analyze the credential variations to determine the level of risk using AI or ML techniques and to determine a breach score of the user. In an implementation, risk analyzer 220 may determine the breach score based at least on a function of reuse, complexity, and variation of credentials used by the user. In an example implementation, risk analyzer 220 may determine the breach score based at least on one of an amount of information of the user that was included as a part of the one or more breaches or an identification of a website, application, or service that the one or more breaches happened within.

In an example implementation, risk analyzer 220 may determine the level of risk based on the results of the credential reuse analysis. For example, a password that is determined to be reused may be determined to be a “high risk” password. In some example implementations, risk analyzer 220 may determine the level of risk based on the credential complexity analysis. For example, a password that is determined to be of high complexity may be determined to be a “low risk” password. In some example implementations, risk analyzer 220 may determine the level of risk based on the result of the credential variation analysis. For example, a password that displays low variation may be considered to be a “high risk” password. In some example implementations, risk analyzer 220 may determine the level of risk based on a combination of one or more of the credential reuse analysis, the credential complexity analysis, or the credential variation analysis. In an implementation, the level of risk may be represented as a percentage, as a number, or any other numerical or relative representation. In an example, the level of risk may be represented as a part of the breach score. The components of the level of risk may be weighted differently to be calculated onto the breach score.

In an example implementation, the breach score of the user may be determined using equation (1) provided below.

$$BS = Weight 1 ( reuse ) + \frac{1}{Weight 2} ( variation ) + \frac{1}{Weight 3} ( complexity ) + Weight 4 \sum ( \# of instances of type of non - credential data ) \qquad ( 1 )$$

where, BS represents the breach score and weight1 for “reuse” is a binary Yes/No, i.e., 1, 0 respectively of a match between multiple credentials associated with the user involved in a breach. Further, the variation has a weight2 for the amount of variation, where low, medium, and high variation may correspond to values of 1, 2, and 3, respectively, and the complexity has a weight3 for the amount of complexity where low, medium, and high complexity may correspond to values of 1, 2, and 3, respectively. According to implementation, if there are no credentials included in the breach, the breach score may be based on the number of instances of non-credential data (or an amount of non-credential data) found in the breach data and the type of information the non-credential data happens to be. Accordingly, the breach score of the user is determined even if the credentials are not included as a part of the breach. Other ways to calculate the breach score of the user are possible and whilst not explicitly discussed, are contemplated herein.

In an example, a phone number may have a weight4 of 3, while a user's location may have a weight4 of 2. The higher the breach score, the higher may be the vulnerability of the user to a malicious attack. In some implementations, the breach score may be determined based on the breach data and the public data, the amount of time that has passed since the breach, the results of the breach analysis, and other factors. In an example, a breach score may qualitatively or quantitatively identify a likelihood that the breach data can be used to assist a malicious actor in gaining access to the organization's systems.

According to implementation, remedial action manager 222 may be configured to take a remedial action with respect to the user based at least on the breach score of the user. In an example, remedial action manager 222 may be configured to take a remedial action if the user has a poor breach score or if the breach score of the user is above a pre-determined threshold. In an implementation, remedial action manager 222 may utilize AI or ML techniques to determine the remedial action based on the breach score. Examples of the remedial action include, but are not limited to, providing a notification that a breach has occurred, prompting the user to change user credentials, or allowing creation of a simulated phishing communication for the user. In an implementation, remedial action manager 222 may send a request to simulated phishing campaign manager 224 for creation of the simulated phishing communication. In an example, remedial action manager 222 may send a notification to the security authority that there has been a breach. In response to receiving the notification, the security authority may request the user to change his or her organizational credentials. In some implementations, remedial action manager 222 may directly send a notification to the user about the occurrence of the breach.

In an implementation, remedial action manager 222 may take a remedial action tailored to the breach score. For example, if the breach score is above the pre-determined threshold and corresponds to high risk, remedial action manager 222 may prompt the user to change his or her password (to prevent unauthorized access to the organization's system). In some implementations, remedial action manager 222 may not take any remedial action with respect to the user. In an example, if the breach score is below the pre-determined threshold and corresponds to low risk, remedial action manager 222 may not take any remedial action.

According to an implementation, in response to receiving the request for creation of the simulated phishing communication, simulated phishing campaign manager 224 may execute a simulated phishing campaign. The simulated phishing campaign may include one or more simulated phishing communications. The simulated phishing campaign may be carried out for specific purposes including giving enhanced training to more vulnerable groups of users in the organization. In an example, the simulated phishing campaign may be executed for testing the users' awareness of phishing techniques and the users' ability to identify the phishing attacks. For example, the simulated phishing campaign may be executed in order to test and develop cybersecurity awareness of the users.

In an implementation, simulated phishing campaign manager 224 may be configured to create, design, edit, and configure the simulated phishing campaign, or allow the security authority to do so. In scenarios where the security authority manages the simulated phishing campaign, simulated phishing campaign manager 224 may provide necessary tools to the security authority for tailoring of content of the simulated phishing campaign and for configurability, control, and automation of execution of the simulated phishing campaign. According to some implementations, simulated phishing campaign manager 224 may execute multiple simulated phishing campaigns of different designs to be targeted against the users using different simulated phishing communications.

In an implementation, simulated phishing campaign manager 224 may create a simulated phishing communication using one or more of the breach data, the organizational data, or the public data. In an implementation, the breached credentials of the user may be used to create the simulated phishing communication displaying a variation of the breached credentials that are partially obscured to lend credence to the simulated phishing communication. In some implementations, the breach data may be used to create the simulated phishing communication to lend credence to the simulated phishing communication. In an example, short codes may be used to extract information from the breach data to place in the simulated phishing communication. According to an implementation, simulated phishing campaign manager 224 may create the simulated phishing communication based on a simulated phishing template. In an example, the simulated phishing template may include dynamic elements or content. For example, the simulated phishing template may be customizable to include one of a specific user reference or content. Accordingly, the simulated phishing template may be customized according to a single user or a group of users, such that the simulated phishing communication generated using the simulated phishing template is contextually more relevant to the user or group of users. In an example, dynamic fields may specify, for example, a user's name, an organization's name, a date, a user's phone number, and so forth. Thus, the simulated phishing communication may be individually tailored, personalized or customized.

In an example implementation, the simulated phishing template may include dynamic fields where the user's breach data may be used for creation of the simulated phishing communication. In an example, the simulated phishing template may include short codes for certain breach data such as “breach phone number” or “breach password” to notify simulated phishing campaign manager 224 to use a phone number or a password from the breach data for the user when the simulated phishing communication is generated from simulated phishing template. In an implementation, simulated phishing campaign manager 224 may create the simulated phishing template using resources available with security awareness system 120. In some implementations, the security authority may create the simulated phishing template.

According to an implementation, simulated phishing campaign manager 224 may use the organizational data to create the simulated phishing communication. In an example, using the organizational data that may not be known publicly to create the simulated phishing communication may allow security awareness system 120 to simulate a breach of the user's organization and prepare the user against phishing attacks. According to an example, simulated phishing campaign manager 224 may create the simulated phishing communication by including the user's organizational credentials. For example, simulated phishing campaign manager 224 may create the simulated phishing communication that includes organizational data such as the user's employee number. In an implementation, simulated phishing campaign manager 224 may create the simulated phishing communication using a simulated phishing template that is themed based on the organizational data such as logos, images, colors, color schemes, and any other data associated with the organization.

According to an implementation, simulated phishing campaign manager 224 may use the public data to create the simulated phishing communication. In an implementation, simulated phishing campaign manager 224 may create the simulated phishing communication using a simulated phishing template that is themed based on publicly available information about the user. In an example, simulated phishing templates may be created based on information associated with an Instagram® account of the user if the user is found to have an Instagram® profile in their public data.

In an implementation, simulated phishing campaign manager 224 may use data regarding the one or more other organizations that were breached for creating the simulated phishing communication. For example, if there is a Zoom® breach, a simulated phishing template that is created based on information associated with Zoom® may be used for creation of the simulated phishing communication. In some examples, a simulated phishing template that is created based on a similar videoconferencing service, such as WebEx®, may be used for creation of the simulated phishing communication.

In an implementation, the one or more other organizations that were breached may include a videoconferencing-based organization. In such a scenario, simulated phishing campaign manager 224 may create the simulated phishing communication related to a videoconferencing service. In some implementations, simulated phishing campaign manager 224 may create a simulated phishing template that appears to be from a completely different service, however simulated phishing campaign manager 224 may use the breach data to create the simulated phishing template. According to an example, in case of a Zoom® breach, partially obscured credentials from the Zoom® breach may be used in the simulated phishing communication that may appear to be from Twitter®. In an example, simulated phishing campaign manager 224 may determine that the user has a Twitter® account from the public data associated with the user.

According to an implementation, simulated phishing campaign manager 224 may communicate the simulated phishing communication to the user. In an example, simulated phishing campaign manager 224 may communicate the simulated phishing communication to the user via an email. In some examples, simulated phishing campaign manager 224 may insert the simulated phishing communication directly into a mailbox of the user. In some examples, simulated phishing campaign manager 224 may communicate the simulated phishing communication to the user through other means, such as a voice message, Short Message Service (SMS), and or any other form of electronic messaging. Other ways to communicate the simulated phishing communication to the user are possible and whilst not explicitly discussed, are contemplated herein. Although the present disclosure describes that simulated phishing campaign manager 224 communicates a single simulated phishing communication to the user, in some implementations, simulated phishing campaign manager 224 may communicate more than one simulated phishing communication to the user.

According to some embodiments, if the user interacts with the simulated phishing communication, the user may be provided with training (i.e., security awareness training) to minimize the attack surface of the user. In an implementation, on receiving the simulated phishing communication, if the user interacts with the simulated phishing communication in any way, training manager 226 may be configured to determine appropriate training for the user. According to an implementation, simulated phishing campaign manager 224 may send a result of the simulated phishing campaign to training manager 226. In an example implementation, training manager 226 may use the AI or ML technique to determine the appropriate training for the user.

In an implementation, training manager 226 may provide training to the user on use of the organizational login credentials and general password hygiene. For example, training manager 226 may provide training related to choosing strong passwords and avoiding password reuse and password sharing. In an example, the training may focus on the reuse of passwords if the user is determined to have reused his or her password. In some examples, the training may focus on good password hygiene, for example, by avoiding the use of similar or identical passwords for different accounts. In an example implementation, the training may focus on credentials of other organizations if the user's credentials are breached many times in those organizations. In an example implementation, training manager 226 may determine training for the user based on a job title or industry of the user. In an example, training manager 226 may recommend appropriate compliance training for the user, such as Sarbanes-Oxley Act (SOX), Health Insurance Portability and Accountability Act (HIPPA), International Organization for Standardization (ISO), and Payment Card Industry (PCI). In an implementation, risk analyzer 220 may adjust the breach score based on the user's response to the simulated phishing communication, assessed user behavior, completion of training by the user, and/or any other attribute that can be associated with the user. In an example, risk analyzer 220 may adjust the breach score of the user after the training based on subsequent actions that the user takes, such as based on compliance or non-compliance with the training within a defined timeframe. For example, when the user is prompted to complete a training, risk analyzer 220 may adjust the breach score of the user based on the user's subsequent actions. In an example, risk analyzer 220 may adjust the breach score according to the timeframe in which the user acted. In an implementation, risk analyzer 220 may determine whether the user completed the training or not within the defined timeframe. In an example, if the user completes the training within the defined timeframe, the breach score of the user may go down. In some examples, if the user does not complete the training within the defined timeframe, the breach score of the user may go up. According to an implementation, security awareness system 120 may create a dashboard of metrics for the security authority to monitor and report on the breach attack surface, the breach score, the remedial action, and the training.

According to aspects of the present disclosure, security awareness system 120 is enabled to determine the amount of risk the credentials from the breach may pose to the user and the organization. Accordingly, security awareness system 120 provides security awareness training to the user to minimize attack surface of the user. As a result, the organization is protected by limiting the ability of malicious actors to deduce the user's credentials and gain unauthorized access to the organization's system, without gaining unauthorized access to the user's accounts.

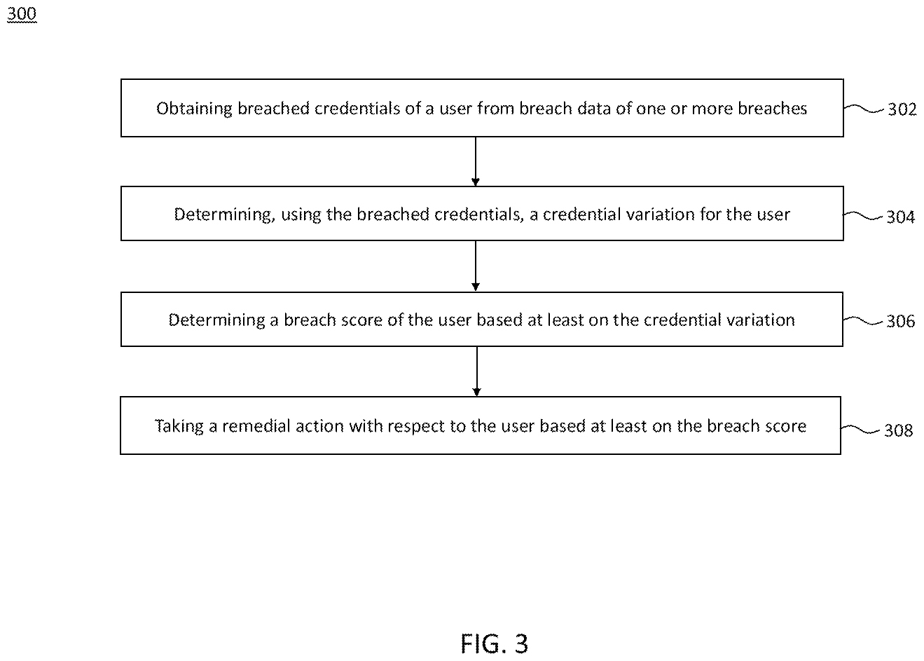

FIG. 3 depicts flowchart 300 for taking a remedial action with respect to a user based on a breach score, according to some embodiments.

In a brief overview of an implementation of flowchart 300, at step 302, breached credentials of a user are obtained from breach data of one or more breaches. At step 304, credential variation for the user is determined using the breached credentials. At step 306, a breach score of the user is determined based at least on the credential variation. At step 308, a remedial action with respect to the user is taken based at least on the breach score.

Step 302 includes obtaining breached credentials of a user from breach data of one or more breaches. According to an implementation, security awareness system 120 may obtain breached credentials of the user from the breach data of one or more breaches. In an implementation, security awareness system 120 may search the breach data for the breached credentials of the user.

Step 304 includes determining, using the breached credentials, a credential variation for the user. According to an implementation, security awareness system 120 may determine, using the breached credentials, the credential variation for the user. In an implementation, security awareness system 120 may analyze the breached credentials of the user in comparison to organizational credentials of the user to determine the credential variation for the user. In an example implementation, security awareness system 120 may determine the credential variation based at least on one or more of a number of characters that are different between the breached credentials and the organizational credentials of the user, and words within strings of the breached credentials and the organizational credentials of the user that are different but related based on one or more rules, categories, or public data.

Step 306 includes determining a breach score of the user based at least on the credential variation. According to an implementation, security awareness system 120 may determine the breach score of the user based at least on the credential variation. In an implementation, security awareness system 120 may determine the breach score based at least on a function of reuse, complexity and variation of credentials used by the user. In an example implementation, security awareness system 120 may determine the breach score based at least on one of an amount of information of the user that was included as a part of the one or more breaches or an identification of a web site, application, or service that the one or more breaches happened within.

Step 308 includes taking a remedial action with respect to the user based at least on the breach score. According to an implementation, security awareness system 120 may take the remedial action with respect to the user based at least on the breach score. In an implementation, security awareness system 120 may take the remedial action of one of providing a notification that a breach occurred, prompting the user to change user credentials, or allowing the creation of a simulated phishing communication to be sent to the user.

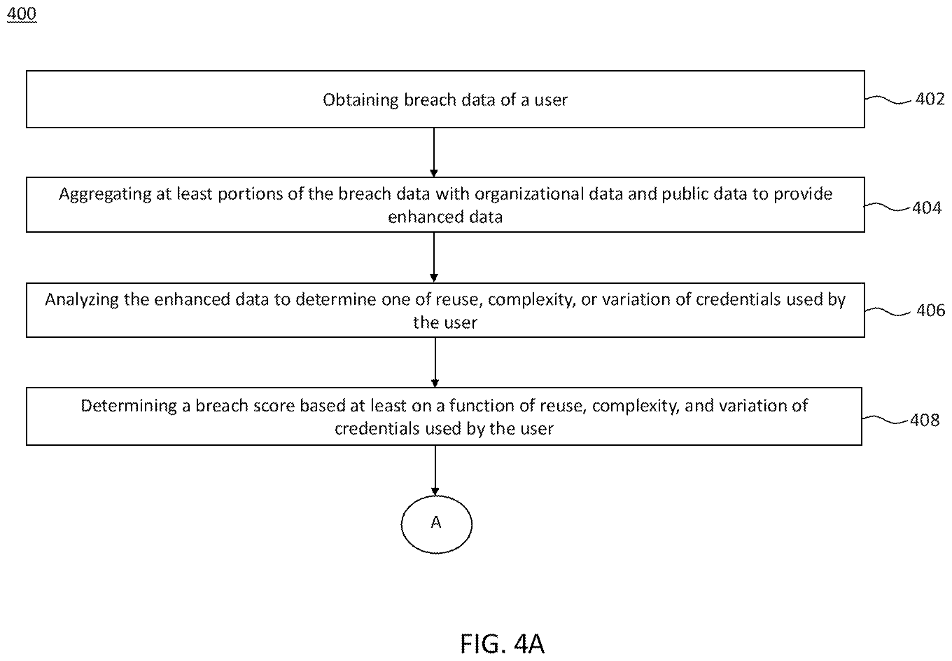

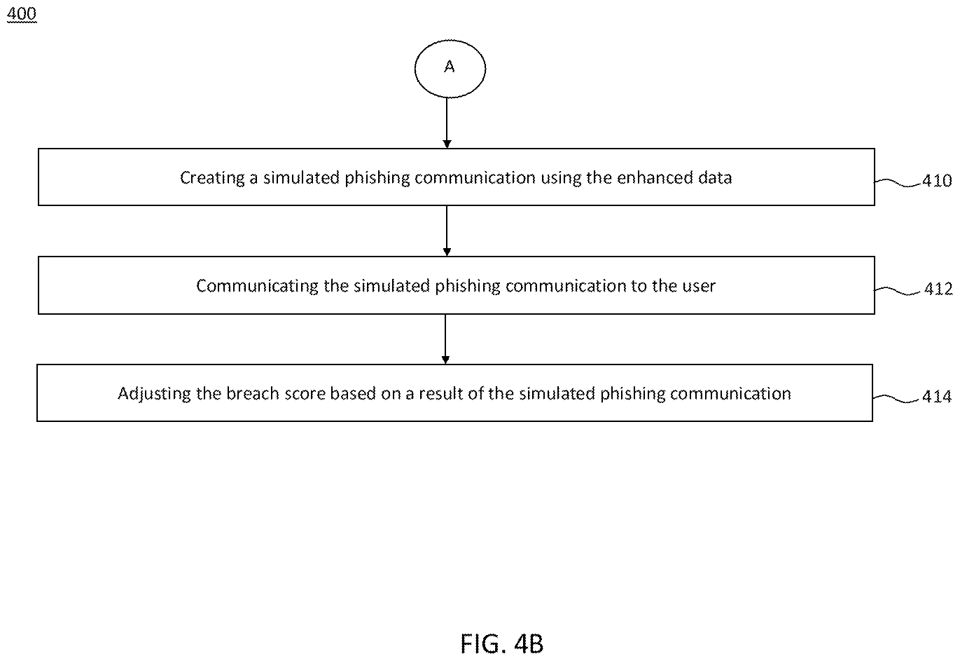

FIG. 4A and FIG. 4B depict flowchart 400 for creating a simulated phishing communication for a user, according to some embodiments.

In a brief overview of an implementation of flowchart 400, at step 402, breach data of a user is obtained. At step 404, at least portions of the breach data are aggregated with organizational data and public data to provide enhanced data. At step 406, the enhanced data is analyzed to determine one of reuse, complexity, or variation of credentials used by the user. At step 408, a breach score is determined based at least on a function of reuse, complexity, and variation of credentials used by the user. At step 410, a simulated phishing communication is created using the enhanced data. At step 412, the simulated phishing communication is communicated to the user. At step 414, the breach score is adjusted based on a result of the simulated phishing communication.

Step 402 includes obtaining breach data of a user. According to an implementation, security awareness system 120 may obtain the breach data of the user.

Step 404 includes aggregating at least portions of the breach data with organizational data and public data to provide enhanced data. According to an implementation, security awareness system 120 may aggregate at least portions of the breach data with the organizational data and the public data to provide enhanced data.

Step 406 includes analyzing the enhanced data to determine one of reuse, complexity, or variation of credentials used by the user. According to an implementation, security awareness system 120 may analyze the enhanced data to determine one of reuse, complexity, or variation of credentials used by the user.

Step 408 includes determining a breach score based at least on a function of reuse, complexity, and variation of credentials used by the user. According to an implementation, security awareness system 120 may determine the breach score based at least on the function of reuse, complexity, and variation of credentials used by the user. In an example implementation, security awareness system 120 may determine the breach score based at least on one of an amount of information of the user that was included as a part of the one or more breaches or an identification of a website, application or service that the one or more breaches happened within. In an example implementation, security awareness system 120 may determine the breach score based on the type of information that was included as a part of the one or more breaches. In an example implementation, security awareness system 120 may determine the breach score based on the amount and type of non-credential data that was included as a part of the one or more breaches.

Step 410 includes creating a simulated phishing communication using the enhanced data. According to an implementation, security awareness system 120 may create the simulated phishing communication of high complexity and high subtlety using the enhanced data. In some implementations, security awareness system 120 may create the simulated phishing communication using one or more of the breach data, the organizational data, or the public data.

Step 412 includes communicating the simulated phishing communication to the user. According to an implementation, security awareness system 120 may communicate the simulated phishing communication to the user.

Step 414 includes adjusting the breach score of the user based on a result of the simulated phishing communication. According to an implementation, risk analyzer 220 may adjust the breach score of the user based on a result of the simulated phishing communication.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A method comprising:
obtaining, by one or more servers, breached credentials of a user from breach data of one or more breaches;
determining, by the one or more servers using the breached credentials, a credential variation for the user;
determining, by the one or more servers, a breach score of the user based at least on the credential variation; and
taking, by one or more servers, a remedial action with respect to the user based at least on the breach score.

2. The method of claim 1, further comprising analyzing, by the one or more servers, the breached credentials of the user in comparison to organizational credentials of the user to determine the credential variation for the user.

3. The method of claim 1, further comprising searching, by the one or more servers, the breach data for the breached credentials of the user.

4. The method of claim 1, further comprising aggregating, by the one or more servers, at least portions of the breach data with organizational data to provide enhanced data.

5. The method of claims 4, further comprising analyzing, by the one or more servers, the enhanced data to determine one of reuse, complexity or variation of credentials used by the user.

6. The method of claim 5, further comprising determining, by the one or more servers, the breach score based at least on a function of reuse, complexity and variation of credentials used by the user.

7. The method of claim 1, further comprising determining, by the one or more servers, the credential variation based at least on one or more of the following: a number of characters that are different between the breached credentials and the organizational credentials of the user, words within strings of the breached credentials and the organizational credentials of the user that are different but related based on one or more rules, categories or public data.

8. The method of claim 1, further comprising determining, by the one or more servers, the breach score based at least on one of an amount of information of the user that was included as a part of the one or more breaches or an identification of a website, application or service that the one or more breaches happened within.

9. The method of claim 1, further comprising communicating, by the one or more servers, a simulated phishing communication to the user, the simulated phishing communication created using one or more of the breach data, organizational data or public data.

10. The method of claim 1, further comprising taking, by the one or more servers, the remedial action of one of: providing a notification that a breach occurred, prompting the user to change user credentials, or allowing the creation of a simulated phishing communication to the user.

11. A system comprising:
one or more servers configured to:
identify breached credentials of a user from breach data of one or more breaches;
determine, using the breached credentials, a credential variation for the user;
determine a breach score of the user based at least on the credential variation; and
take a remedial action with respect to the user based at least on the breach score.

12. The system of claim 11, wherein the one or more servers are further configured to analyze the breached credentials of the user in comparison to organizational credentials of the user to determine the credential variation for the user.

13. The system of claim 11, wherein the one or more servers are further configured to search the breach data for the breached credentials of the user.

14. The system of claim 11, wherein the one or more servers are further configured to aggregate at least portions of the breach data with organizational data to provide enhanced data.

15. The system of claim 14, wherein the one or more servers are further configured to analyze the enhanced data to determine one of reuse, complexity or variation of credentials used by the user.

16. The system of claim 15, wherein the one or more servers are further configured to determine the breach score based at least on a function of reuse, complexity and variation of credentials used by the user.

17. The system of claim 11, wherein the one or more servers are further configured to determine the credential variation based at least on one or more of the following: a number of characters that are different between the breached credentials and the organizational credentials of the user, words within strings of the breached credentials and the organizational credentials of the user that are different but related based on one or more rules, categories or public data.

18. The system of claim 11, wherein the one or more servers are further configured to determine the breach score based at least on one of an amount of information of the user that was included as a part of the one or more breaches or an identification of a website, application or service that the one or more breaches happened within.

19. The system of claim 11, wherein the one or more servers are further configured to communicate a simulated phishing communication to the user, the simulated phishing communication created using one or more of the breach data, organizational data or public data.

20. The system of claim 11, wherein the one or more servers are further configured to take the remedial action of one of: providing a notification that a breach occurred, prompting the user to change user credentials, or allowing the creation of a simulated phishing communication to the user.
